(19) United States
(12) Patent Application Publication
(10) Pub. No.: US 2007/0299579 A1
(43) Pub. Date: Dec. 27, 2007

(54) Universal automobile operating system

(76) Inventor: Frederick Njuki, Conroe, TX (US)

Correspondence Address: Frederick Njuki MD, 206A S Loop 336W #114, Conroe, TX, 77304, US

(21) Appl. No.: 11/726,474

(22) Filed: Mar. 22, 2007

Related U.S. Application Data
(60) Provisional application No. 60/744,175, filed on Apr. 3, 2006.

(51) Int. Cl. G06F 19/00; G06F 1/00

(52) U.S. Cl. 701/36

(57) ABSTRACT

This invention describes a device to replace automobile audio and visual systems with a standard computer capable of running an automobile optimized operating system. This invention describes a computer software and hardware system that integrates a computer operating system to replace the automobile audio and visual system. The audio system that this invention would replace the FM, AM radio and, satellite broadcasts as well as MP3 or other audio formats on the market. The invention would allow installation of software driven integrated mobile phone system. The operating system would enable the user to install 3rd party software for GPS navigation, satellite radio broadcasts, play MP3 or other audio software.

### STATEMENT OF RELATED CASES

This application claims the benefit of U.S. Provisional Application No. 60/744,175, filed Apr. 3, 2006.

### DESCRIPTION

An automobile computer hardware and software system designed to take over the functions of the audio and visual equipment, such as in-car satellite navigation, radio, CD player and cell phone functions. This system will bring to the automobile, software programs available on the handheld and personal computer market. The GPS navigation software available on many new automobiles models is far inferior to handheld versions running on Palm operating system or PocketPC operating system. The updates from manufacturers are not as frequent as updates of software bought directly from vendors.

This invention would open the automobile software market to developers. This at present is a closed market. Automobile manufacturers are slow at providing firmware updates on the existing factory installed GPS and audio systems. The Bluetooth implementation in factory installed systems is also inferior to existing 3rd party products available for handhelds and cell-phones on the market. This invention will bring many more developers to this market and free the automobile owners from the dealers, and allow the car owner to install any software of their choice, much like on a home PC. The invention would open a market for aftermarket computer devices with automobile owners being able to install the devices on used vehicles through authorized dealers in much the same way that DVD players are installed in used automobiles. The invention can be used by automobile dealers to perform diagnostics through service menus in the operating system. Corporations managing large fleets of vehicles such as law enforcement, FedEx and UPS can have custom software developed for them without having custom computer devices to run the software.

What is claimed is:

1. What is claimed is an automobile computer capable of running several different operating systems.

2. What is claimed is an operating system capable of running on 1 and able to run, on existing handheld or desktop computers.

3. What is claimed is an automobile computer system to replace the current factory installed in-car entertainment systems with a universal operating system based 3^{rd} party software.
